(19) United States
(12) Patent Application Publication
(10) Pub. No.: US 2016/0035348 A1
(43) Pub. Date: Feb. 4, 2016

(54) Speech-Based Search Using Descriptive Features of Surrounding Objects

(71) Applicant: NUANCE COMMUNICATIONS, INC., Burlington, MA (US)

(72) Inventors: Jan Kleindienst, Nove Straseci (CZ); Ladislav Kunc, Hlusice (CZ); Martin Labsky, Praha 4 (CZ); Nils Lenke, Rheinbach (DE); Tomas Macek, Praha 3 (CZ)

(73) Assignee: Nuance Communications, Inc., Burlington, MA (US)

(21) Appl. No.: 14/775,778

(22) PCT Filed: Jun. 7, 2013
(86) PCT No.: PCT/US13/44714

§ 371 Date: Sep. 14, 2015

(51) Int. Cl. G10L 15/187; G10L 15/18; G10L 15/24; G10L 15/26; G10L 15/197

(52) U.S. Cl. CPC G10L 15/187; G10L 15/26; G10L 15/197; G10L 15/24; G10L 15/1822

(57) ABSTRACT

A natural language query arrangement is described for a mobile environment. An automatic speech recognition (ASR) engine can process an unknown speech input from a user to produce corresponding recognition text. A natural language understanding module can extract natural language concept information classifier uses the from the recognition text. A query recognition text and the natural language concept information to assign to the speech input a query intent related to one or more objects in the mobile environment. An environment database contains information descriptive of objects in the mobile environment. A query search engine searches the environment database based on the query intent, the natural language concept information, and the recognition text to determine corresponding search results, which can be to the user.

### TECHNICAL FIELD

The invention generally relates to natural language processing and understanding, and more specifically, to a natural language query arrangement for use in mobile applications.

### BACKGROUND ART

An automatic speech recognition (ASR) system determines a semantic meaning of a speech input or utterance. Typically, the input speech is processed into a sequence of digital speech feature frames. Each speech feature frame can be thought of as a multi-dimensional vector that represents various characteristics of the speech signal present during a short time window of the speech. For example, the multi-dimensional vector of each speech frame can be derived from cepstral features of the short time Fourier transform spectrum of the speech signal (MFCCs)—the short time power or component of a given frequency band—as well as the corresponding first- and second-order derivatives (“deltas” and “delta-deltas”). In a continuous recognition system, variable numbers of speech frames are organized as “utterances” representing a period of speech followed by a pause, which in real life loosely corresponds to a spoken sentence or phrase.

The ASR system compares the input utterances to find statistical acoustic models that best match the vector sequence characteristics and determines corresponding representative text associated with the acoustic models. More formally, given some input observations A, the probability that some string of words W were spoken is represented as P(W|A), where the ASR system attempts to determine the most likely word string:

$$\hat{W} = arg {max}_{W} P ( W \vert A )$$

Given a system of statistical acoustic models, this formula can be re-expressed as:

$$\hat{W} = arg {max}_{W} P ( W ) P ( A \vert W )$$

where P(A|W) corresponds to the acoustic models and P(W) reflects the prior probability of the word sequence as provided by a statistical language model.

The acoustic models are typically probabilistic state sequence models such as hidden Markov models (HMMs) that model speech sounds using mixtures of probability distribution functions (Gaussians). Acoustic models often represent phonemes in specific contexts, referred to as PELs (Phonetic Elements), e.g. triphones or phonemes with known left and/or right contexts. State sequence models can be scaled up to represent words as connected sequences of acoustically modeled phonemes, and phrases or sentences as connected sequences of words. When the models are organized together as words, phrases, and sentences, additional language-related information is also typically incorporated into the models in the form of a statistical language model.

The words or phrases associated with the best matching model structures are referred to as recognition candidates or hypotheses. A system can produce a single best recognition candidate the recognition result or multiple recognition hypotheses in various forms such as an N-best list, a recognition lattice, or a confusion network. Further details regarding continuous speech recognition are provided in U.S. Pat. No. 5,794,189, entitled “Continuous Speech Recognition,” and U.S. Pat. No. 6,167,377, entitled “Speech Recognition Language Models,” the contents of which are incorporated herein by reference.

Recently, ASR technology has advanced enough to have applications that are implemented on the limited footprint of a mobile device. This can involve a somewhat limited stand-alone ASR arrangement on the mobile device, or more extensive capability can be provided in a client-server arrangement where the local mobile device does initial processing of speech inputs, and possibly some local ASR recognition processing, but the main ASR processing is performed at a remote server with greater resources, then the recognition results are returned for use at the mobile device. U.S. Patent Publication 20110054899 (incorporated herein by reference) describes a hybrid client-server ASR arrangement for a mobile device in which speech recognition can be performed locally by the device and/or remotely by a remote ASR server depending on one or more criteria such as time, policy, confidence score, network availability, and the like.

Natural Language Processing (NLP) and Natural Language Understanding (NLU) involve using computer processing to extract meaningful information from natural language inputs such as human generated speech and text, for example, ASR text results. One recent application of such NLU technology is processing speech and/or text queries in mobile devices such as smartphones. FIG. 1 A-C shows some example screen shots of one such mobile device application, Dragon Go!, which processes speech query inputs and obtains simultaneous search results from a variety of top websites and content sources. Such applications require adding a natural language understanding component to an existing web search algorithm in order to extract semantic meaning from the input queries. This can involve using approximate string matching to discover semantic template structures. One or more semantic meanings can be assigned to each semantic template. Parsing rules and classifier training samples can be generated and used to train NLU models that determine query interpretations (sometimes referred to as query intents).

### SUMMARY

Embodiments of the invention are directed to a natural language query arrangement for a mobile environment using automatic speech recognition (ASR). An ASR engine can process an unknown speech input from a user to produce corresponding recognition text. A natural language understanding module can extract natural language concept information from the recognition text. A query classifier uses the recognition text and the natural language concept information to assign to the speech input a query intent related to one or more objects in the mobile environment. An environment database contains information descriptive of objects in the mobile environment. A query search engine searches the environment database based on the query intent, the natural language concept information, and the recognition text to determine corresponding search results. A user communication interface can deliver the search results to the user.

The mobile environment can include an environment in and around a vehicle containing the user and/or an environment around a smartphone receiving the speech input and delivering the search results. The natural language concept information can include descriptive properties of one or more objects in the mobile environment, points of interest information descriptive of objects in the landscape around the user, and/or information from a vehicle manual. The query search engine can further base its search on information from one or more environment sensors measuring one or more properties of the mobile environment.

### BRIEF DESCRIPTION OF THE DRAWINGS

FIG. 1 A-C shows various example screen shots from an ASR-NLU application for a mobile device.

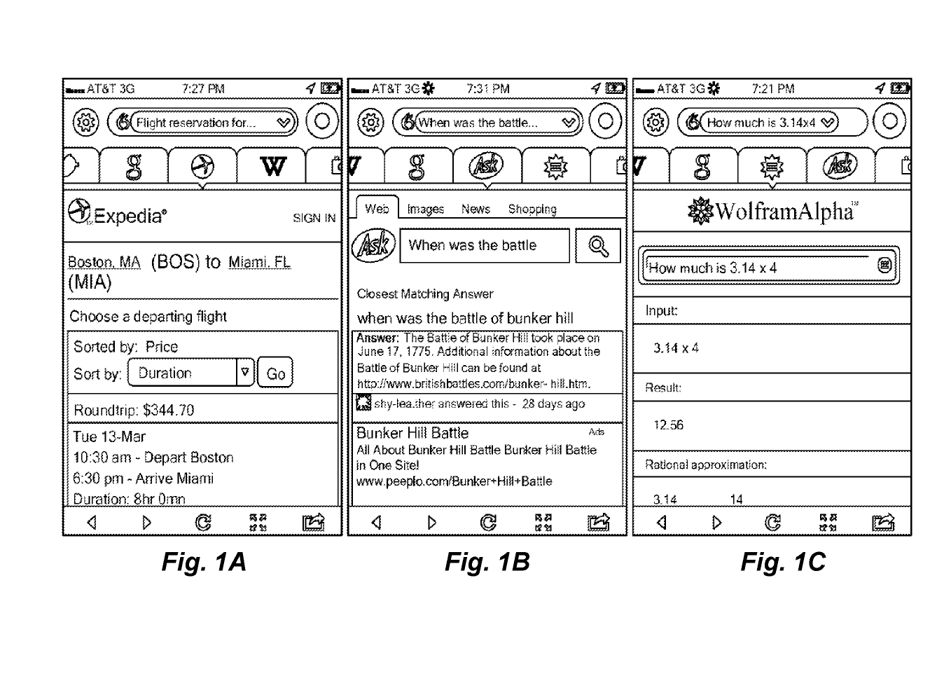

FIG. 2 shows various functional elements in a natural language query arrangement for a mobile environment.

FIG. 3 shows various functional steps in a natural language query process.

### DETAILED DESCRIPTION

Conventional speech-based natural language systems allow a user to search for information about objects by saying the object's name and then searching a database for this name. But this approach requires that the user has to remember the exact correct name of the object. Situations can suddenly arise in a vehicle environment where a driver is unexpectedly warned or informed about potential problems by various indicators, lights or sounds. In the stress of the immediate moment, a driver often does not remember the meaning of different indicators and warning lights. That hinders the driver's ability to quickly determine the best response that solves the issue.

An improved approach to this problem can be based on extracting object properties from a recognized natural language utterance spoken by the driver/user, and thereby allow the user to search for objects using natural language descriptive phrases such as:
“I see the orange engine light blinking . . . ”
“The blue icon is shining . . . ”
“A buzzer sounded three times . . . ”
“The mountain on the left side . . . ”

Thus embodiments of the invention are directed to a natural language query arrangement for a mobile environment which enables the user to use natural language to enter queries for information about the environment such as surrounding objects (landmarks, etc.) and in-car objects (lights, sounds, etc.) by entering typical descriptive information (position, color, type). The system then can perform advanced searching in knowledge bases such as the car owner's manual and point-of-interest databases using natural language descriptions of objects. Among other advantages, such arrangements should enable faster and safer resolution of vehicle-related events using a speech enabled guide or wizard. Both static and dynamic saliency can be exploited for reference resolution.

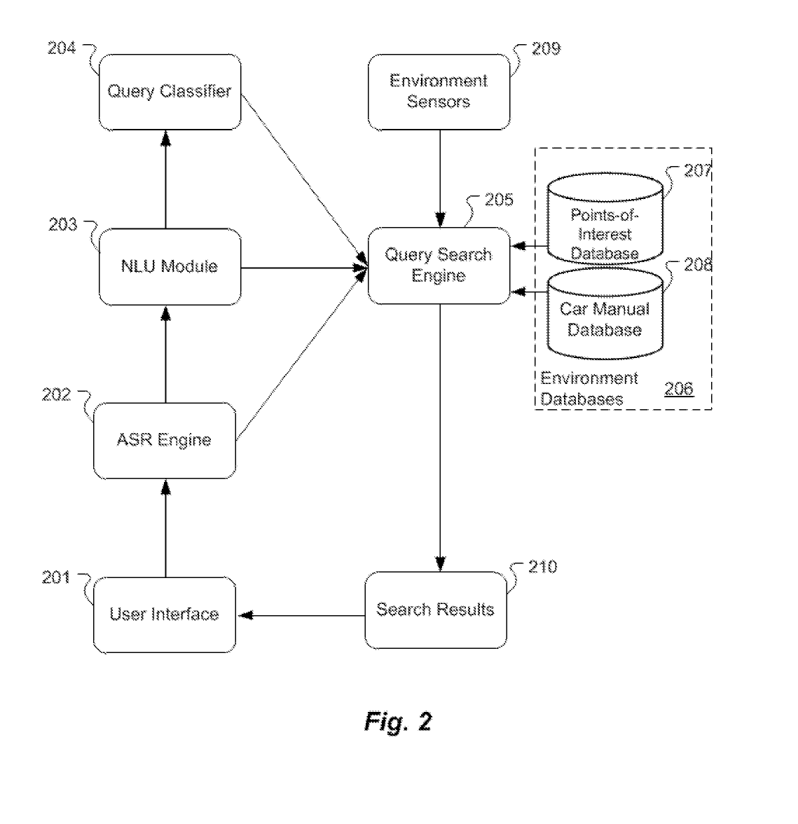

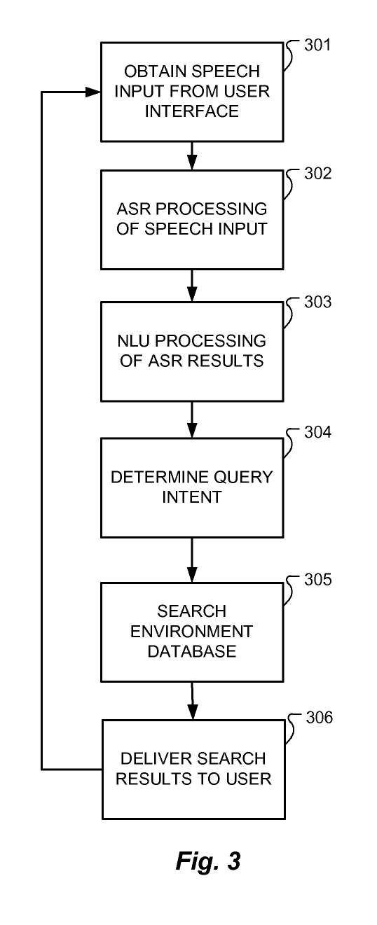

FIG. 2 shows various functional elements in a natural language query arrangement and FIG. 3 shows various functional steps in a natural language query process for a mobile environment according to an embodiment of the invention. A user interface 201 includes a microphone to obtain unknown speech inputs (one or more utterances or natural language queries), from a user (e.g., a driver or passenger traveling in a car), step 301, that describe properties of one or more objects in the environment such as the outside landscape or the interior of the vehicle.

In certain embodiments, the user interface 201 can be a hand held mobile device, a smart phone or an automobile head unit. In some embodiments, the user interface 201 includes a hand held mobile device in communication with an automobile head unit. The user interface 201 can be an application miming on the hand held mobile device, smart phone or automobile head unit.

The speech inputs received by the user interface 201 are provided to an ASR engine 202 that produces corresponding recognition text, step 302. The ASR engine 202 can be a local embedded application, server-based, or a hybrid client/server arrangement. The ASR engine 202 can perform speech recognition using grammars and/or language models to produce the text.

A natural language understanding module 203 augments the text from the ASR engine 202 with NLU classes and annotations describing the requested object properties. The NLU module 203 can be a local embedded application, server-based, or a hybrid client/server arrangement.

The NLU module 203 extracts natural language concept information (object properties such as locations, shapes, colors, etc.) from the recognition text, step 303. In some embodiments, examples of the descriptive feature classes extracted by the NLU module 203 from the recognition text include:
Color—object color description (e.g. white, yellow, light green, magenta . . . )
Shape—object shape description (e.g. rectangular, oval, rounded, box, sphere . . . )
Location—object location description (e.g. on the dashboard, in the middle, right, left . . . )
Location-To-Object—object location description using another object (e.g. right to the speedometer, on the left side of dashboard . . . )
Object-Inscription—object title/inscription (e.g. icon with ABS sign, icon with ESP acronym . . . )
Visual-Behavior—visual behavior of object (e.g. blinking, illuminated . . . )
Sound-Features—description of sounds (e.g. alarm played, beeping (beep) . . . )
   These feature classes are encoded as named entities in the transcribed user utterance. Using word-level annotations, the NLU module 203 can represent the NLU feature classes: “What does the <Visual-Behavior>blinking</Visual-Behavior> <Color>red</Color> icon <Location-To-Object>left to the speedometer</Location-To-Object>means?”

A query classifier 204 uses the recognition text and natural language concept information to assign a query intent to the speech input. The query intent can be a category, and can be related to one or more objects in the mobile environment referred to by the user in the input, step 304. The query classifier 204 can be a local embedded application, server-based, or a hybrid client/server arrangement.

An environment database 206 contains information descriptive of objects in the mobile environment which includes the environment in and around the vehicle containing the user and/or the environment around the smartphone receiving the speech input and delivering the search results. An environment database 206 can include a point-of-interest (POI) database 207 and/or a car manual database 208. An environment database 206 can be a local application onboard a vehicle or mobile application or can be situated in a hosted environment. The environment database 206 can be a hosted database from which information is retrieved by the query search engine 205 or other module of the arrangement.

Car manual database 208 can be an internal or external car owner's manual containing natural language concept information regarding the vehicle and its interior environment. The car manual database 208 can include information specific to a particular make/model of vehicle and/or can include information generic to any make/model of vehicle.

The car manual database 208 can be a hierarchical database of salient concepts from the automotive domain (e.g. Brakes->Changing brakes, Navigation->Search for POIs . . . ) with full-text description and textual description of concept properties and features (location, color, shape, warning pattern, etc.) plus a mechanism to dynamically update the car manual database 208 based on information received from the car control system, e.g., if an error occurred and a related warning lamp has been activated.

The natural language concepts maintained in the car manual database 208 include both required and optional description fields. Description field categories can include:
Name (title) of a concept—descriptive title of car specific concept (e.g. driving through water, changing windshield wipers, usage of spare tire . . . )
Full-text description of a concept—Full-text paragraphs of a plain text that describes the concept.
Procedure steps description—Some concepts are procedures (e.g. checking the engine oil, checking the brake fluid . . . ) and need to be specified as a sequence of steps. This can be done by encoding the full-text description of each step separately (e.g. <item order=“1”>Move the button to unlock position</item> <item order=“2”>Press the unload button to eject the CD</item> . . . )
Descriptive features—Features that describe the concept. The features can be location, shape, color, etc.
Situation description—description of situations that can arise in connection with the concept or situations that the concept solves. (e.g. “spare tire change” concept->my tire is broken).

The natural language query arrangement can stay aware of the current location of the vehicle and the environment database 206 can include a points-of-interest database 207 containing natural language concept information such as descriptive properties of one or more objects in the mobile environment such as objects in the landscape around the user. The objects in the points-of-interest database 207 are divided into object categories such as bridges, mountains, gas stations, restaurants, etc. The points-of-interest database 207 describes each object textually and includes location information such as geographic coordinates. Each concept includes one or more of the following descriptive fields:
Category—Point-of-interest classification (e.g. swimming pool, hotel, restaurant, bridge . . . )
Name (title) of a place—title of place (e.g. White House, Big Ben, Hilton hotel . . . )
Full-text description of a place—Full-text paragraphs of a plain text that describes the place.
Location Position of the place—latitude and longitude coordinates.
Descriptive features—Description of a place or landmark using features as color shape . . . (e.g. golden tower, red bridge . . . )

A query search engine 205 searches the environment database 206, step 305, based on the query intent, natural language concept information, and recognition text to determine corresponding search results. The query search engine 205 can be a local embedded application, server-based, or a hybrid client/server arrangement.

The extracted properties of the object referred to by the user are used as pointers to the concepts in the environment database 206. For example, these properties can be individual words (e. g. “red”, “blue”, “left”, . . . ) or multiword phrases (e. g. “instrument cluster”, “windshield wiper”, . . . ). The query search engine 205 can base its search on information from one or more environment sensors 209 measuring one or more properties of the mobile environment. The query search engine 205 discovers queries such as: “I see the orange light of engine blinking what should I do?” “The blue icon is shining what does this mean?” “What happens if I ignore the orange light warning?” etc.

Environment sensors 209 can be vehicle sensors characterizing the condition of various vehicle systems and objects (e.g., speed, direction, location, time of day, temperature, climate zone, urban/rural environment, landscape information, roadway conditions, hazards, traffic, position or characteristics of other vehicles). Environment sensors 209 can be onboard a vehicle or can be sensors of a mobile device (e.g., a handheld mobile or smartphone). The conditions can be derived from information received from environment sensors 209. Query search engine 205 can directly determine the conditions or can receive the conditions from a separate module.

The query search engine 205 uses the correct specific search procedure according to the classification of the user's query by the query classifier 204:
General Definition—Asking for general definition of an object (e.g. keyless entry, what is the ESP, what is the rain sensor . . . )
Question and Answers—Asking question that can be answered in natural language (e.g. what is the recommended inflation of front tires? Where is the fuel cap? How do I turn on windshield wipers? etc.
Descriptive features query—Searching for an object using descriptive features that are not the object name (e.g. what is the mountain on the right side? I see an orange light blinking what should I do? etc.
Procedure search—Querying to find out a guidance procedure (e.g. how to change a flat tire? How do I fill windshield washer? etc.

In the specific case of a descriptive features query search, a search index is created, for example by building a concept-term matrix that describes how strongly each term determines each concept by means of floating point score numbers. Some parts (e.g. titles, feature-based descriptions . . . ) of index scores can be boosted or lowered according to their significance. The index can be divided into three parts:
titles of concepts
full-text of concepts
features (properties) of concepts
   During runtime, a user query is first tokenized into terms which are scored using index scores from the appropriate matrices. For example, if a term in the user query is annotated as one of the NLU classes (e.g. color, shape, location . . . ); it is scored using the feature description index matrix. A list of results is then compiled such that the concept with the highest score is first and other concepts are ordered from the highest to the lowest score.

The query search engine 205 then summarizes information about relevant matching objects and presents its results to the user via the user interface 201 using synthesized speech and/or a multimodal user interface that supports other interaction mechanisms such as handwriting, keyboard input and other natural language inputs, step 306. For example, the query search engine 205 can access and search troubleshooting or frequently asked question lists so that the described process acts to guide the user to identify and resolve the issue using a wizard technique.

Specific embodiments can take into account that some descriptions are more salient than others (esp. in the automotive field). Therefore, a model of concept saliency can be useful to improve accuracy of the concept result list from the query search engine 205. Salience is related to objects, which are more or less salient to a given set of environmental circumstances. According to the concept saliency, the query search scores are lowered or boosted.

Model salience can be distinguished as static salience or dynamic salience. Static salience can be computed offline and stored together with other information in the environment database 206. Factors influencing the saliency are:
Location—Indicators in the center of dashboard or on a head-up display (HUD) are more salient than indicators located far from the driver's view.
Color—signal colors (red, yellow etc.) make an object more salient than others.
Size—bigger objects are more salient than others.
Amount of text in the car manual (POI data base/other sources) available on this object. Objects (e.g. buttons) on which there is more information available in the car manual (measured by text size) are more salient than other objects.

In addition, dynamic saliency can be based on information available in a specific moment and is computed at runtime for the query search engine 205 describing objects that are related to an error state or other relevant event (incoming message, phone call etc.). This is often tied to a visual behavior a blinking or illuminated sign (icon) is more salient than a dark one. Instead of computing a dynamic salience score for all objects, the system can keep a list of dynamically salient objects that is updated in regular intervals (e.g. every minute) or upon an asynchronous event (car sensor spots a problem and starts a flashing lamp).

User descriptions of objects can be ambiguous, e.g. “the red lamp” can refer to three red lamps in the vehicle cockpit. Especially when one of the lamps is much more salient to the user than similar objects, they are likely to not specify the object further. For example, when one of three red lamps of different size suddenly blinks the user will often just say: “what does the red lamp mean”, not “what does the medium sized red button mean”. Without taking saliency into account, the system would be forced to start a clarification dialog with the user (“which red lamp do you mean, the small, medium, or big one”) which is potentially distracting. Instead embodiments having saliency models will work as follows. If the NLU analysis by the NLU module 203 returns a set of objects to which a certain phrase could refer that includes more than one object that fit the description, the system will use static and dynamic salience to try and resolve the ambiguity. If one of the candidate objects returned from the NLU analysis is in the list of dynamically salient objects, or if one has a much higher static saliency score than all others, than it is selected without further disambiguation.

In embodiments of the invention such described above, system users do not need to remember or know the name of a nearby object to search for information about that object. Describing the object/landmark to the system in natural language using its properties makes for a natural and intuitive interaction process.

NLU module 203, query classifier 204, and query search engine 205 can be embodied in one or more software modules or processors. In certain embodiments, query classifier 204 and query search engine 205 form one module and communicate in a hosted environment with one or more of user interface 201, ASR engine 202, NLU module 203, environment database 206, and sensors 209.

In certain embodiments, query classifier 204 can receive information from ASR engine 202 and/or NLU module 203, and determine intent of the user. The query classifier 204 can deliver to the query search engine 205 the recognition text, the natural language concept information and the query intent. The query classifier 204 can receive the search results from the query search engine 205 and deliver or control delivery of the search results to the user via the user interface 201.

User interface 201 can deliver search results 210 via a display, e.g., an automobile head unit, a HUD or a screen of a mobile device or smartphone. In some embodiments, the search results 210 can be read aloud to the user via user interface 201. Based on text output from the query search engine 205, speech can be synthesized by user interface 201 locally or by a hosted module. In certain embodiments, query search engine 205 synthesizes speech based search results and delivers them to user interface 201 for read out to the user.

User interface 201 can utilize a wake up word to initiate the natural language query arrangement, or the natural language query arrangement can be always on and decipher requests. User interface 201 can employ a dialog with user to deliver more timely or accurate information, and can deliver an advertisement or third party information based on the intent of the query.

Embodiments of the invention can be implemented in part in any conventional computer programming language such as VHDL, SystemC, Verilog, ASM, etc. Embodiments of the invention can be implemented as pre-programmed hardware elements, other related components, or as a combination of hardware and software components.

Embodiments can be implemented in part as a computer program product for use with a computer system. Such implementation can include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium can be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions can be stored in any memory device, such as semiconductor, magnetic, optical or other memory devices, and can be transmitted using any communications technology, such as optical, infrared, microwave, or other transmission technologies. It is expected that such a computer program product can be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention can be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method for processing natural language queries in a mobile environment employing at least one hardware implemented computer processor, the method comprising:
extracting natural language concept information from text recognized by an automatic speech recognition (ASR) engine;
using the text and the natural language concept information to assign to the speech input a query intent related to one or more objects in the mobile environment; and
based on the query intent, the natural language concept information, and the recognition text, searching an environment database containing information descriptive of the one or more objects in the mobile environment to determine corresponding search results.

2. The method of claim 1 further comprising processing an unknown speech input from a user with the ASR engine to produce the text.

3. The method of claim 1 wherein the mobile environment includes an environment in and around a vehicle containing the user.

4. The method of to claim 1 wherein the mobile environment includes an environment around a smartphone receiving the speech input and delivering the search results.

5. The method of to claim 1 wherein the natural language concept information includes descriptive properties of one or more objects in the mobile environment.

6. The method of to claim 1 wherein the environment database includes points of interest information descriptive of objects in the landscape around the user.

7. The method of to claim 1 wherein the environment database includes information from a vehicle manual.

8. The method of to claim 1 further comprising searching the environment database based on information from one or more environment sensors measuring one or more properties of the mobile environment.

9. A computer program product, tangibly embodied in a non-transitory computer-readable medium, for processing natural language queries in a mobile environment, the computer program product including instructions operable to cause a data processing apparatus to:
extract natural language concept information from text recognized by an automatic speech recognition (ASR) engine;
use the text and the natural language concept information to assign to the speech input a query intent related to one or more objects in the mobile environment; and
based on the query intent, the natural language concept information, and the recognition text, search an environment database containing information descriptive of the one or more objects in the mobile environment to determine corresponding search results.

10. An apparatus for processing a natural language query related to one or more objects in a mobile environment, the apparatus comprising:
a query classifier for using (i) text recognized by an automatic speech recognition (ASR) engine and (ii) natural language concept information extracted from the text to assign to the natural language query a query intent related to the one or more objects in the mobile environment; and
a query search engine for searching an environment database based on the query intent, the natural language concept information, and the text to determine search results.

11. The apparatus of claim 10 further comprising an environment database containing information descriptive of the one or more objects in the mobile environment.

12. The apparatus of claim 10 further comprising an ASR engine for processing an unknown speech input from a user to produce the text.

13. The apparatus of claim 10 further comprising a natural language understanding module for extracting the natural language concept information from the text.

14. The apparatus of claim 10 wherein the natural language concept information includes descriptive properties of one or more objects in the mobile environment.

15. The apparatus of claim 11 wherein the environment database includes points of interest information descriptive of objects in the landscape around the user.

16. The apparatus of claim 11 wherein the environment database includes information from a vehicle manual.

17. The apparatus of claim 10 wherein the query search engine further bases its search on information from one or more environment sensors measuring one or more properties of the mobile environment.
